(19) United States
(12) Patent Application Publication
(10) Pub. No.: US 2007/0126163 A1
(43) Pub. Date: Jun. 7, 2007

(54) Compact, high-force air spring assembly and vehicle suspension system

(75) Inventors: John R. Leonard, Arcadia, IN (US); Brad W. Munchel, Franklin, IN (US)

Correspondence Address: Attn: Michael R. Huber;Bridgestone Americas Holding, Inc., Chief Intellectual Property Counsel, 1200 Firestone Parkway, Akron, OH, 44317-0001, US

(73) Assignee: BFS Diversified Products, LLC

(21) Appl. No.: 11/294,208

(22) Filed: Dec. 5, 2005

(51) Int. Cl. F16F 9/04

(52) U.S. Cl. 267/64.27; 267/64.28

(57) ABSTRACT

An air spring and damper assembly includes a damper having an internal fluid pressure of approximately 175 psi or greater, and an air spring supported on the damper. The air spring and damper assembly can be used as components in a vehicle suspension system. The air spring and damper assembly can also be used as components of a kit.

### BACKGROUND

The present novel concept broadly relates to the art of vehicle suspension systems and, more particularly, to an air spring assembly having a compact size and high load capacity, as well as a vehicle suspension system utilizing the same.

Air springs are generally known and commonly used in a variety of applications and environments, including vehicle suspension systems. It has been recognized that air springs are capable of withstanding substantial loads, and it is well understood that the load capacity of an air spring has a direct relation to the air pressure within the air spring as well as the amount of effective surface area upon which that pressurized air acts. As such, by selectively sizing an air spring and operating that air spring at a predetermined air pressure or within a predetermined pressure range, it is possible to optimize the size and performance of an air spring to meet the specific requirements of an application.

For example, vehicle suspension systems often utilize air springs as primary suspension springs, such as on over-the-road (OTR) tractors and/or trailers. Due to the nature and construction of these types of vehicles, sufficient operating space or clearance is normally available for the installation of air springs that are sized to support the anticipated vehicle loads while operating at a standard air pressure level or within a standard pressure range, which is commonly from approximately 60 psi to approximately 120 psi. These types of vehicle suspension systems also include a suitable damping member (e.g., a shock absorber) that is mounted separately from but, often, adjacent to the air spring.

As an alternative to use as a primary suspension component, air springs can also be used as supplemental or “helper” springs that provide a vehicle with increased load capacity and/or performance over that provided by the primary suspension springs alone, which are often steel springs, such as leaf, coil or torsion springs. For example, supplemental air springs are used on commercial trucks and other heavy-duty vehicles that regularly transport heavy loads to improve the performance of the vehicle when heavily laden. As another example, supplemental air springs can be used to augment the existing suspension of an older vehicle. In these types of vehicle applications there is normally sufficient clearance between the unsprung and sprung masses of these vehicles to mount the supplemental air springs. In this respect, the air spring installation is similar to arrangements used for primary air spring suspensions. As a result, few limitations are placed on the size of the air spring and the available clearance normally allows the supplemental air spring to be properly sized to provide the desired amount of additional load capacity and/or performance.

In other vehicle applications, however, the design and structure of the vehicle can significantly limit the space available for the installation air springs. This often occurs in lighter-duty vehicles that are less expansive than OTR tractors and/or heavy duty, commercial vehicles. These lighter-duty vehicles are often more aesthetically oriented as well, and this combination of smaller stature and increased aesthetic componentry can significantly restrict the available space for mounting suspension components. As such, there is often insufficient clearance between the body or frame of the vehicle and the corresponding wheel-engaging members to directly mount an air spring therebetween. As such, other types and kinds of suspension assemblies have been developed and are often used.

One example of an alternate arrangement of a suspension assembly that can be used on vehicles having reduced or limited clearance for mounting the same is an air spring-over-damper assembly. These assemblies include a damper that has an air spring mounted on it such that the damper and air spring extend and retract together, usually in a substantially co-axial manner. Such assemblies are often then mounted within an envelope that is relatively limited in size, such as a space that was originally intended to receive only a damper, for example. Typically, though, the envelope is of sufficient size to receive the air spring and damper assembly and to permit the same to operate in a proper manner with minimal or no modification to the vehicle itself, provided that a relatively modest sized air spring is used.

Installing air spring and damper assemblies of this type on a vehicle, such as on each front corner thereof, for example, will normally result in substantial improvement in the performance and/or handling of the vehicle. However, the use of such a relatively small diameter air spring typically only increases the load capacity of the vehicle suspension by a small amount. This is generally found to be acceptable, however, because the load on the front end of such a passenger vehicle or pick-up truck does not, during normal use, change in any significant amount. Because the increase in performance and handling generally justifies the installation of supplemental suspension springs, air spring-over-damper assemblies are often utilized to attain the increased performance in spite of the relatively low increase in load capacity.

There are, however, certain applications that can generate substantial loads on the front end of these types of lighter-duty vehicles. One such application, for example, includes the securement and use of a snowplow on the front end of the vehicle. In addition to the plow blade itself, the structural mounting elements and the electric/hydraulic control system must also be mounted on the vehicle and are typically supported on the front end thereof. The added weight of this equipment can be significant and can undesirably change the performance and handling of the vehicle. As such, it would be useful to employ supplemental suspension springs in such applications. As discussed above, however, clearance is usually unavailable for the direct mounting of supplemental air springs between a wheel-engaging member and the vehicle body.

As an alternative, known air spring-over-damper assemblies have been considered for use in these types of applications. However, the area available to receive the air spring is often quite limited and it is generally not possible to increase the available space without undesirable modifications to the vehicle. As such, known air spring-over-damper assemblies have been found to provide an insufficient increase in load capacity to be useful in such applications. This can be at least partially attributed to the modest diameter of the air spring coupled with the operation of the same at a standard air pressure or within a standard air pressure range.

Since it is not normally possible to increase the size of the air spring in these applications (i.e., those having limited clearance), it has been proposed to increase the pressure within the air spring to thereby increase the load capacity of the air spring. Due to recent achievements in materials and construction methods, air springs capable of withstanding increased pressures have been developed. However, transferring these high-pressure air spring designs to air spring-over-damper assemblies has, to date, been unsuccessful.

For example, initial consideration was given to simply installing an air spring having a relatively high air pressure, such as an air pressure of 150 psi (or greater), for example, over a damper having an internal fluid pressure that was significantly less than 150 psi, such as from about 60 psi to about 120 psi, for example. However, the seal around the damper rod proved incapable of keeping air at such increased pressure levels from interacting with the fluid within the damper. This resulted in various degenerative conditions which undesirably altered the damping characteristics of the damper. As such, attention was directed to other constructions.

Based upon the results of such attempts to install a high-pressure air spring over a damper, constructions having more robust sealing arrangements have been considered. Some such constructions propose the use of additional sealing elements between the housing and damping rod of the damper. In other constructions, sealing members that more tightly or aggressively seal along the damping rod were proposed. However, both of these arrangements introduce other problems that unacceptably alter the performance and durability of the damper. For example, the more robust sealing arrangement tends to significantly increase friction on the damping rod, which can undesirably alter the responsiveness and other characteristics of the damper. What's more, such aggressive sealing arrangements tend to undergo rapid and significant wear. This can create quality and maintenance issues and can result in problems and disadvantages that are similar in nature to those associated with the use of normally sealed dampers in these high-pressure applications.

As such, it is believed desirable to develop an air spring and damper assembly that has the same or similar compact size to that of known air spring and damper assemblies, but which has significantly increased load capacity and/or performance. Furthermore, it is believed desirable to develop a corresponding suspension system that utilizes such an air spring and damper construction.

### BRIEF DESCRIPTION

An air spring and damper assembly in accordance with the present novel concept is provided that includes a damper, an air spring, and a restraining device. The damper includes a first damping portion and a second damping portion displaceably supported on the first damping portion. The first damping portion includes a first wall at least partially defining a damping chamber containing a first quantity of fluid at a nominal pressure of approximately 175 psi or greater. The air spring includes a first end member supported on the first damping portion, a second end member spaced from the first end member and supported on the second damping portion, and a flexible wall secured between the first and second end members and at least partially defining a spring chamber.

A vehicle suspension system in accordance with the present novel concept for use on an associated vehicle having an associated sprung mass, an associated unsprung mass, and an associated electrical power source is provided that includes a plurality of suspension members secured between the associated sprung mass and the associated unsprung mass, a pressurized fluid source, and an electronic control unit. The suspension members include a damper, an air spring, and a restraining device. The damper includes a first damper portion and a second damper portion displaceable relative to the first damper portion. The first damper portion includes a first wall at least partially defining a damper chamber and a first quantity of fluid disposed within the damper chamber at a nominal pressure of approximately 175 psi or greater. The air spring is supported on the damper and includes a first end member supported on the first damper portion, a second end member spaced from the first end member and supported on the second damper portion, a flexible wall secured between the first and second end members and at least partially defining a spring chamber therebetween, and a second quantity of fluid disposed within the spring chamber at a nominal pressure of approximately 175 psi or greater. The restraining device is supported on one of the damper and the air spring and includes a device wall extending along the flexible wall of the air spring. The pressurized fluid source is in communication with the air springs of the plurality of suspension members. The pressurized fluid source is operative to selectively communicate with the second quantity of fluid to the spring chambers of the air springs. The electronic control unit is in communication with the associated electrical power source and the pressurized fluid source and selectively energizes the pressurized fluid source.

A vehicle suspension system kit in accordance with the present novel concept is provided that includes a plurality of dampers, a plurality of air springs, a plurality of restraining devices, a pressurized air source, and an electronic control unit. Each damper of the plurality of dampers includes a first damper portion and a second damper portion displaceable relative to the first damper portion. The first damper portion includes a first wall at least partially defining a damper chamber and a first quantity of fluid disposed within the damper chamber at a nominal pressure of approximately 175 psi or greater. Each air spring of the plurality of air springs is supported on one damper of the plurality of dampers. The air springs include a first end member supported on the first damper portion, a second end member spaced from the first end member and supported on the second damper portion, and a flexible wall secured between the first and second end members and at least partially defining a spring chamber therebetween. Each restraining device of the plurality of restraining devices is supported on a corresponding one of the dampers or the air springs and includes a device wall extending along the flexible wall of a corresponding one of the air springs. The pressurized air source is adapted to selectively supply pressurized fluid of approximately 175 psi or greater. The electronic control is operable to selectively energize the pressurized air source.

### BRIEF DESCRIPTION OF THE DRAWINGS

FIG. 1 is a perspective view of one embodiment of a vehicle suspension system in accordance with the present novel concept shown installed on an associated vehicle.

FIG. 2 is a cross-sectional side view of one embodiment of an air spring and damper assembly in accordance with the present novel concept.

FIG. 3 is an enlarged view of Detail 3 in FIG. 2.

FIG. 4 is an enlarged view of Detail 4 in FIG. 2.

FIG. 5 is a diagram schematically illustrating a relationship between chambers of an air spring and a damper.

FIG. 6 is a diagram illustrating fluid pressure versus load capacity for known air spring and damper assemblies.

FIG. 7 is a diagram illustrating fluid pressure versus load capacity for air spring and damper assemblies in accordance with the present novel concept.

### DETAILED DESCRIPTION

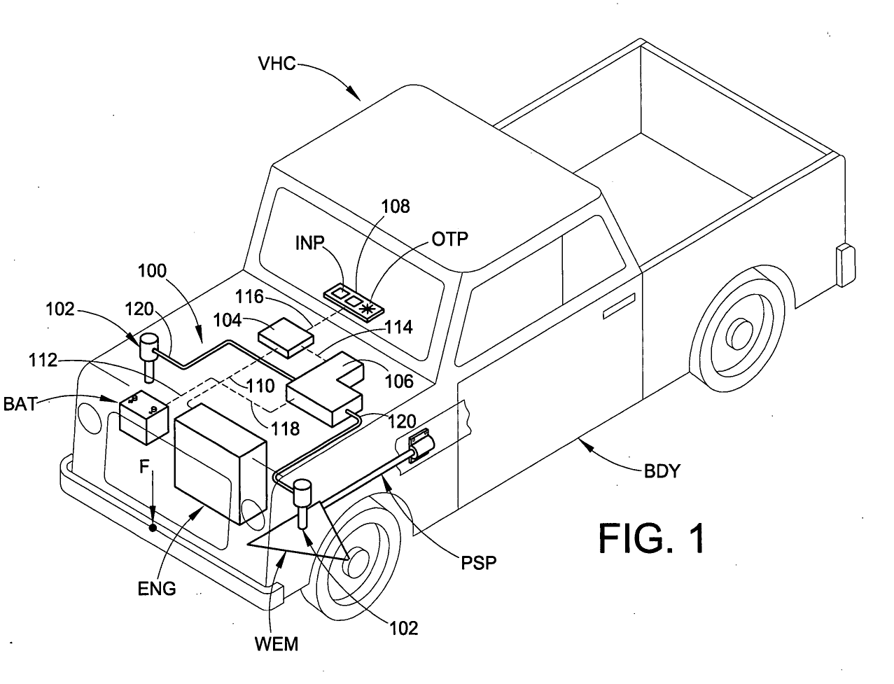

FIG. 1 illustrates one exemplary embodiment of a vehicle suspension system 100 installed on an associated vehicle VHC. The associated vehicle includes an unsprung mass, such as a wheel-engaging member WEM or undercarriage, for example, and a sprung mass, such as a vehicle body BDY, for example, supported on the unsprung mass by suitable suspension members. In the exemplary embodiment shown, the sprung mass is supported on the unsprung mass using primary suspension springs, only one of which is shown in FIG. 1. Primary suspension spring PSP in FIG. 1 is shown as being of a torsion spring design, though it will be appreciated that any suitable type or kind of spring arrangement, such as a coil or leaf spring, for example, could alternately be used. Having indicated that the suspension system of vehicle VHC includes primary suspension springs, it will be recognized that one or more of the embodiments detailed herein is described in use as a supplemental or “helper” spring. However, it is to be distinctly understood that the present novel concept is capable of broad use, including use as a primary suspension spring or component, and that the present novel concept is not intended to be limited to the embodiments and/or use shown herein, which are considered merely exemplary.

Vehicle VHC is shown in FIG. 1 supporting an additional load, indicated generally by arrow F, on the front end of the vehicle. The additional load can be due to the mounting of an after-market component, such as a snow plow, for example, on the exterior of the vehicle. It is to be distinctly understood, however, that the present novel concept is not intended to be limited to used in applications having such additional loads. Vehicle VHC also includes an associated electrical power source suitable for powering electrical components of vehicle suspension system 100. It will be appreciated that any suitable electrical power source, such as engine ENG, battery BAT or auxiliary power unit (not shown), for example, can be used.

Vehicle suspension system 100 includes a plurality of suspension components 102; a controller, such as an electronic control unit (ECU) 104, for example; and a compressed air source, such as a compressor 106, for example. Additionally, the vehicle suspension system can optionally include an operator interface, such as a control panel 108, for example, having input and/or output components, such as buttons and/or switches INP, and/or a display or indicator lights OTP, for example. Electronic control unit 104 is shown as being in electrical communication with engine ENG and/or battery BAT of the vehicle in a suitable manner, such as through leads 110 and/or 112, for example. ECU 104 is also shown as being in electrical communication with compressor 106 and control panel 108 through leads 114 and 116, respectively. Additionally, or in the alternative, compressor 106 can be placed in electrical communication with one or both of engine ENG and/or battery BAT in a suitable manner, such as through lead 118, for example.

Suspension components 102 are in fluid communication with compressor 106 through fluid lines 120. It will be appreciated that other components of air supply systems are well known and can optionally be included in the vehicle suspension system, such as valves, valve blocks, and/or reservoirs, for example. Furthermore, in one exemplary embodiment, one or more pressure or other sensors can be included. If included, such a pressure sensor can be used in conjunction with other component of the system to maintain a minimum level of air pressure within the system. Such a mode of operation could be beneficial, for example, to prevent the full collapse of the air springs and thereby minimize any rubbing or abrading of the air spring components. It is to be distinctly understood that vehicle suspension system 100 is merely one example of a vehicle suspension system in accordance with the present novel concept and that other, more complex and/or sophisticated arrangements are contemplated and can be used.

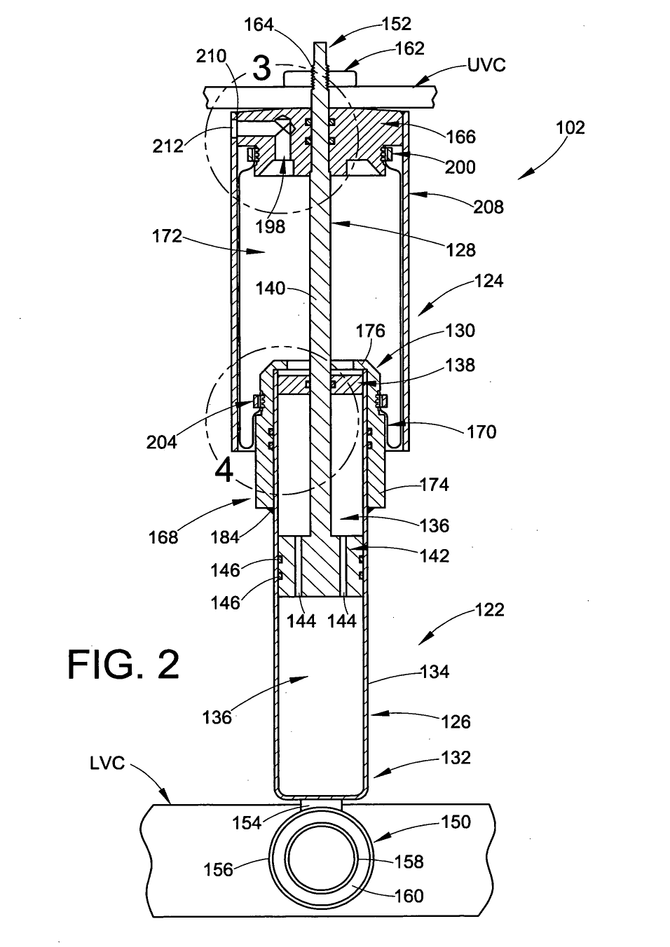

An exemplary embodiment of suspension component 102 is shown in FIGS. 2-4 and includes a damper or damping member 122 and an air spring or fluid spring member 124. Damping member 122 includes a first damper portion, such as damper housing 126, for example, and a second damper portion, such as a damper rod 128, for example, displaceably supported on the first damper portion. Damper housing 126 has a first or open end 130 and a second or closed end 132, and includes a housing wall 134 extending therebetween that at least partially defines a damper chamber 136 within the damper housing. A quantity of damper fluid (not shown), such a suitable hydraulic oil, for example, is disposed within damper chamber 136 and retained therein at open end 130 by an end wall 138.

Damper rod 128 includes an elongated rod portion 140 having opposing ends. A piston 142 is supported on one of the rod ends within damper chamber 136 such that damper fluid is generally disposed on both sides thereof. Piston 142 includes one or more apertures 144 that permit the passage of damper fluid between the opposing sides of the piston. Optionally, apertures 144 can be variable in size or in number of active passages to thereby vary the damping characteristics of damping member 122, as is well understood by those of skill in the art. Additionally, one or more sealing members 146 can be used to form a substantially fluid-tight seal between piston 142 and housing wall 134. Furthermore, a sealing member 148 is secured on end wall 138 and forms a substantially fluid-tight seal with elongated rod portion 140 of damper rod 128 to retain the quantity of damper fluid within damper housing 126.

It will be appreciated that a wide variety of components and constructions are known by those of skill in the art and can be used in forming substantially fluid-tight seals between the piston and housing wall and between the end wall and damping rod. Thus, it will be recognized that the exemplary components and constructions provided herein are merely representative of such suitable components and constructions. Damping member 122 also includes suitable mounting portions for engagement of and/or securement on the vehicle or the suspension system elements thereof. Suitable elements are shown in FIG. 2 as a first or upper vehicle component UVC, such as a vehicle body or a portion thereof, for example, and a second or lower vehicle component LVC, such as a wheel-engaging component, for example.

As one example of a suitable mounting portion of damper 122, a first mounting portion 150 is disposed along damper housing 126, such as along closed end 132, for example. One example of a second mounting portion 152 is disposed along the end of damper rod 128 opposite piston 142. First mounting portion 150 is shown in FIG. 2 as including a securement portion 154, an outer member 156, an inner member 158 and connecting member 160 disposed therebetween. First mounting portion 150 can be secured on the lower vehicle component in any suitable manner, such as by using a fastener (not shown), for example. Second mounting portion 152 is shown in FIG. 2 as being secured on upper vehicle component UVC in any suitable manner, such as by a threaded nut 162 engaging a plurality of threads 164 disposed along the end of the damper rod, for example. It will be appreciated that the first and second mounting portions shown and described herein are merely exemplary and that any other suitable mounting arrangements can alternately be used.

As mentioned above, the foregoing illustration and discussion of damping member 122 is representative of known damping member constructions. Thus, it will be understood that the exemplary embodiment shown and described herein is merely illustrative and that other constructions could alternately be used without departing from the principles of the present novel concept. Damping member 122 differs from other known damping members in that the quantity of fluid therein is maintained at a pressure of approximately 175 psi or greater, whereas typical damping members include fluid maintained at a pressure of less than 150 psi, and most commonly from about 60 psi to about 120 psi. Additionally, it will be appreciated that a pressure of 175 psi is presented herein as an example of a minimum nominal pressure level and that any greater pressure level can alternately be used, such as nominal pressures of approximately 200, 225, 250, 275 and 300 psi, for example. Thus, a suitable construction for the damper will be designed for and capable of withstanding such increased pressure levels. For example, the sealing arrangement between the first and second portions of the damper will be capable of maintaining a dynamic seal between these portions under increased fluid pressures, such as those at or exceeding approximately 175 psi, for example. As another example, the wall portions of the of such a damper will be designed and constructed to withstand these increased pressures without an unacceptable amount of deflection. One example of a suitable damper is available from ThyssenKrupps Bilstein of America located in Mooresville, N.C. under the designation BE5-6081-HO.

Fluid spring member 124 includes a first or upper end member 166 and a second or lower end member 168 spaced from the upper end member. A flexible spring member 170 is disposed between the first and second end members and at least partially forms a fluid chamber 172 therebetween.

Lower end member 168 includes a first or body wall 174 and a second or end wall 176 that extends inwardly from the first wall. First wall 174 includes an inside surface (not numbered) at least partially defining a passage 178 extending through the lower end member such that the lower end member can be received on damper housing 126. One or more grooves 180 can optionally be provided on the lower end member, such as along the inside surface thereof, for example. Optionally, sealing members 182 can be received within the grooves to form a substantially fluid-tight seal between the lower end member and the damper housing.

The lower end members can be secured on the damper housing in any suitable manner, such as by using mechanical fasteners, for example. In such case, it may be desirable to use one or more sealing members, such as sealing members 182, for example, to form the sealing arrangement. As an alternative to using mechanical fasteners, a flowed-material joint 184, such as a weld or soldered or brazed connection, for example, could be used. One benefit of such a construction is that the flowed-material joint can also provide a substantially fluid-tight seal between the two components. Thus, the use of such optional sealing members can be avoided.

Upper end member 166 includes a first or outer side wall 186, a second or intermediate side wall 188 and a third or inner side wall 190 at least partially defining a passage (not numbered) extending through the upper end member. At least a portion of damper rod 128 extends through the passage and engages the upper end member, such as on or along a shoulder 192, for example, formed thereon along the inner side wall. One or more grooves 194 can be formed on or along inner side wall 190 and receive a sealing member 196, such as an o-ring, for example. Additionally, a fluid passage 198 is formed through the upper end member permitting a flow of pressurized fluid into and out of fluid chamber 172.

Flexible spring member 170 extends between upper end member 166 and lower end member 168, and can be secured thereto in any suitable manner. For example, a first open end (not numbered) of flexible spring member 170 can be disposed on or along intermediated side wall 188 of the first end member and secured thereto using a crimped or otherwise deformed retaining ring 200. Optionally, grooves 202 or other similar features can be provided on the end member, such as along intermediate side wall 188, for example, to improve the strength and/or seal of the connection of the flexible spring member on the end member. As another example, a second open end (not numbered) of flexible spring member 170 can be disposed on or along first wall 174 of lower end member 168 and can be secured thereto using a crimped or otherwise deformed retaining ring 204. Optional grooves 206 or other features can also be included to improve the strength and/or seal of the connection of the flexible spring member on the end member.

First wall 174 of lower end member 168 is shown herein as having a substantially cylindrical shape, and it will be recognized that the rolling-lobe formed along flexible spring member 170 will move along at least a portion of this cylindrical wall as the air spring extends and collapses. It will be appreciated, however, that any suitable shape or configuration can alternately be used on or along first wall 174 to provide the spring with any desired characteristics or performance. For example, the first wall could alternately have an upper wall portion that is cylindrical and a lower wall portion that is flared outwardly from the upper wall portion.

Flexible spring member 170 can be of any suitable type, kind or configuration, and can be of any suitable material or construction. For example, the flexible spring member can take the shape of a substantially cylindrical sleeve that is formed from an elastomeric material, such as natural or synthetic rubber, for example. Optionally, the flexible spring member can be formed from a material that is reinforced with filaments, strands, cord, fabric or other constructions of a suitable reinforcing material, such as cotton and/or polyamide-based materials (e.g., nylon, aramid), for example. Additionally, it will be appreciated that the construction of the flexible spring member can be of any suitable type or kind. For example, the flexible spring member can be formed from an elastomeric material that has the optional reinforcing material molded or otherwise embedded into the elastomeric material. As another example, the flexible spring member can be of a multiple-layer or sandwich construction having the optional reinforcing material disposed between layers of elastomeric material. As a further example, the flexible spring member can be formed from one or more layers of elastomeric material, without the use of the optional reinforcing material. It will be appreciated that the selection of a particular construction for any given application will vary based upon the applicability of the features, benefits and characteristics of such a construction to the application at hand, and that one of skill in the art will be capable of selecting an appropriate material or combination of materials from the foregoing or other suitable constructions.

A suspension component, such as suspension component 102, for example, can include an air spring operated at any suitable air pressure, such as about 120 psi, for example, or within any suitable air pressure range, such as from about 60 psi to about 150 psi, for example. In such an arrangement, the suspension component would benefit from the robust construction and performance of the damper but would not maximize the load capacity of the air spring. However, it is to be understood that such a construction and operation is intended to fall within the scope of the present novel concept. As another example, the air spring of the suspension component can be operated at an air pressure of 150 psi or greater, such as at 175 psi, 200 psi, 225 psi, 250 psi, 275 psi or 300 psi, for example, including any pressure or range of pressures that is within or otherwise includes or exceeds these exemplary pressure values. Such a construction and operation will, in at least some applications, more fully utilize the robust construction and performance of the damper as well as maximize the available load capacity of the air spring.

Selection of an appropriate construction for the flexible spring member can be based, at least in part, on the intended operating pressure of the air spring, as discussed above. As will be recognized by the skilled artisan, other considerations for the selection of an appropriate construction could also optionally include the desired fatigue life of the spring member, peak or extreme air pressures acting on the air spring, temperature and/or environmental factors, and manufacturing costs. Another consideration often relates to the envelope or space within which the suspension component will operate. To maintain the air spring within a predetermined operating envelope, a restraining cylinder 208 can be used, as shown in FIGS. 2-4. The restraining cylinder can be of any suitable type, kind or configuration, and can be formed from any suitable material or combination of materials. For example, in one exemplary embodiment, restraining cylinder 208 is substantially cylindrical and can be formed from a metal, such as steel or aluminum, for example. As another example, the restraining cylinder could be formed from a polymeric material, such as a polyamide, for example, or could be manufactured from a composite material, such as a filament wound resin construction, for example.

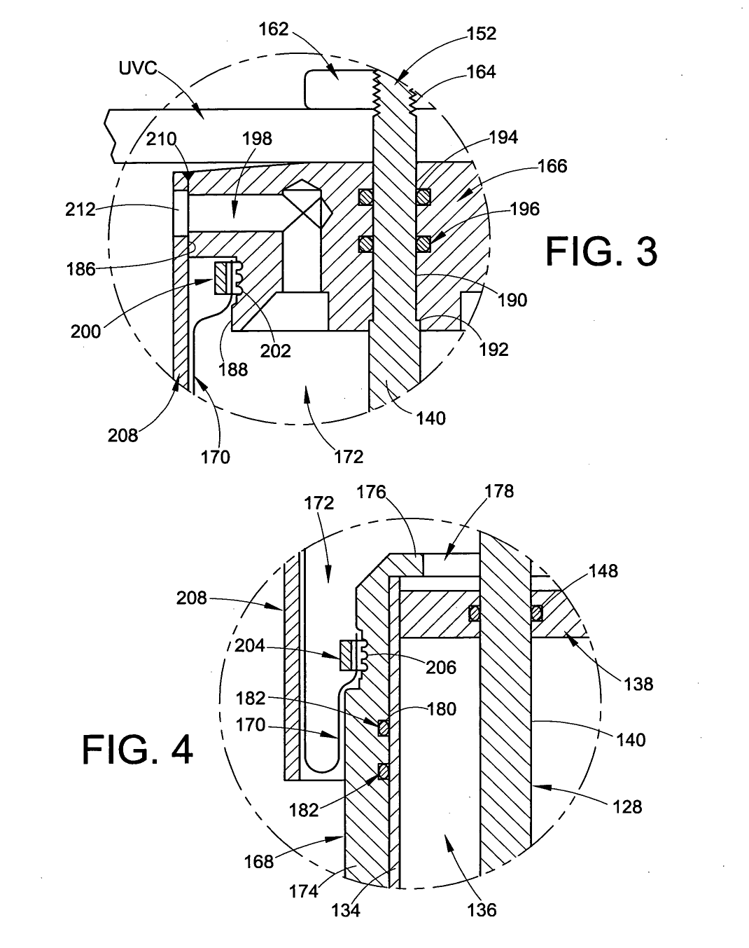

Restraining cylinder 208 can be secured on the suspension component along the air spring thereof in any suitable manner. For example, a metal restraining cylinder could be secured on upper end member 166 using a mechanical fastener or a flowed-material joint, such as a weld joint 210 in FIGS. 2 and 3, for example. If provided, restraining cylinder 208 can include an opening 212 in communication with fluid passage 198 to permit fluid flow therethrough.

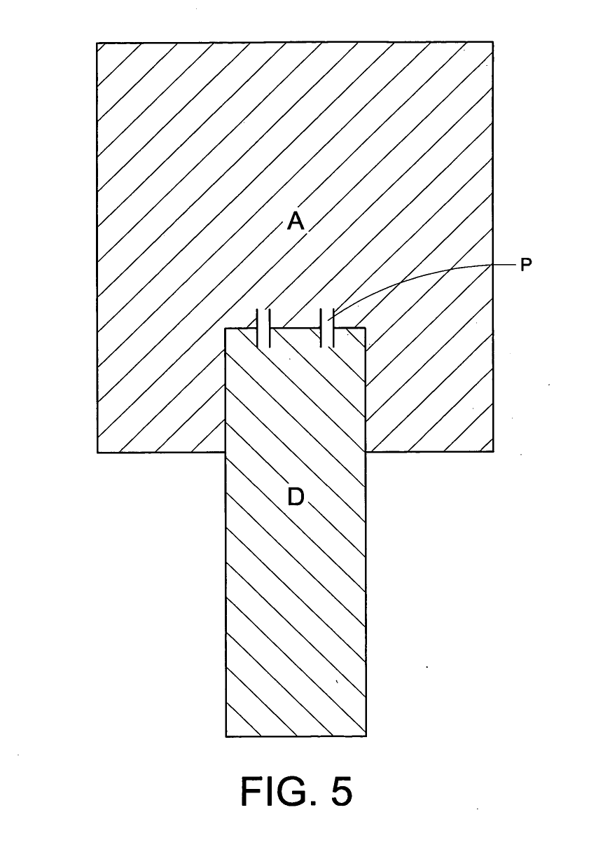

FIG. 5 illustrates a relationship between the pressurized fluids of a damper and air spring assembled together as a suspension component, such as damping member 122 and air spring 124 of suspension component 102, for example. The pressurized fluid in the air spring is indicated by reference character A, and the pressurized fluid in the damper is indicated by reference character D. Passages P are shown extending between the two components and represent fluid communication through the sealing arrangement disposed between the damper housing and the damper rod, as has been discussed above in detail.

Generally, the dynamic sealing arrangement between the damper housing and the damper rod will be biased in one direction. That is, the sealing arrangement will be configured more to maintain the pressurized damping fluid within the damper housing than to keep other, external fluid or fluids outside the housing. This may have contributed to the lack of success of efforts to use a high-pressure air spring on a typical damper, as has been discussed above in detail. Thus, where pressurized fluid D is at a relatively low pressure and pressurized fluid A is at a higher pressure, pressurized fluid A may be able to enter the housing through passage P because the seal and pressurized fluid D acting on the seal will not be enough to overcome the force of pressurized fluid A. However, where pressurized fluid D is at a high pressure, the effect of the seal and pressurized fluid D acting on the seal is enough to prevent the creation of a passage, such as passage P, along the sealing arrangement. Thus, a low-pressure air spring or one operating a significantly increased pressure can be used over a high-pressure damper.

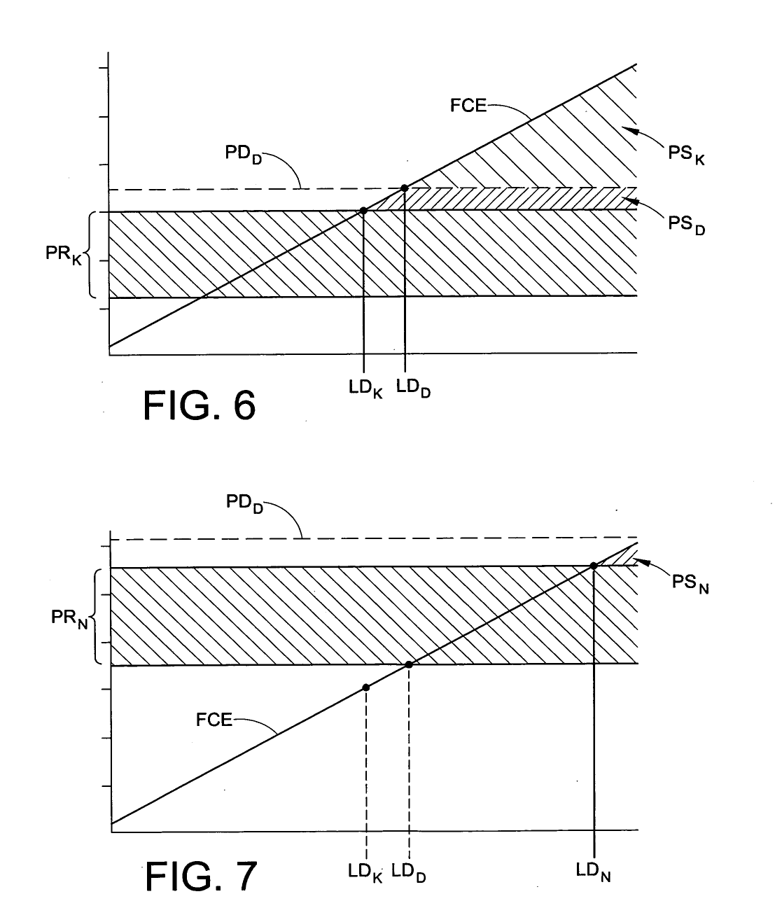

FIG. 6 illustrates a pressure versus load diagram for known air spring over damper suspension components. FIG. 7 illustrates a pressure versus load diagram for an air spring over damper arrangement in accordance with the present novel concept. Assuming the operative area of an air spring remains constant, a line FCE in FIGS. 6 and 7 represents an increase of force or load capacity as the pressure within the air spring increases. In FIG. 6, a known pressure range PR_{K} represents the internal pressure of a damper used in an air spring and damper assembly in accordance with known practice. One example of such a range is shown in FIG. 6 as being from about 60 psi to about 150 psi. It is expected that a dynamic sealing arrangement of such a damper can withstand an external fluid pressure differential of about 15% over the pressure of the fluid within the damper. This differential pressure is represented by dashed line PR_{D} and is shown in the diagram of FIG. 6 as being about 173 psi. At the high end of range PR_{K}, an air spring would be capable of supporting a load LD_{K} as indicated by the point where line FCE crosses or exceeds the high end of the range. An area PS_{D} is formed between line FCE and the upper end of range PR_{K} that represents an external air pressure within the seal differential pressure which may or may not cause a passage to form through the damper seal. An area PS_{K} between line FCE and differential pressure line PR_{D} represents an external air pressure above the seal differential pressure at which a passage would be expected to form through the damper sealing arrangement. Thus, a maximum expected load capacity of an air spring over a damper having an internal pressure within range PR_{K}, would have an expected maximum load capacity of about load LD_{K} and possibly as much as load LD_{D}.

By utilizing a damping member having an internal pressure that is significantly greater than in known air spring and damper suspension components, it is possible to significantly increase the load capacity of an equally-sized air spring. As illustrated in FIG. 7, a pressure range PR_{N} represents the internal fluid pressure of a damper used in an air spring and damper assembly in accordance with the present novel concept. One example of such a range is shown in FIG. 7 as being from about 175 psi to about 275 psi. Again, it is expected that the dynamic sealing arrangement of the damper will withstand an external fluid pressure of at least 15% over the pressure of the fluid within the damper. This differential pressure is represented by dashed line PR_{D} and is shown in the diagram of FIG. 7 at about 315 psi.

As mentioned above, a line FCE in represents an increase of force or load capacity as the pressure within an air spring increases. The point at which line FCE crosses or otherwise exceeds pressure range PR_{N} corresponds the approximate load LD_{N} that an air spring operating at that pressure would be capable of supporting. For reference purposes, loads LD_{K} and LD_{D} are also shown on the diagram in FIG. 7. Based upon a comparison of load LD_{N} with these reference loads, it is clear that a substantial increase in load capacity is achieved. What's more, it may be possible to further increase the load capacity by utilizing an area PS_{N} between line FCE and the upper extent of pressure range PR_{N}.

While the subject novel concept has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles of the subject novel concept. Obviously, modifications and alterations will occur to others upon reading and understanding the preceding detailed description. Accordingly, it is to be distinctly understood that the foregoing descriptive matter is to be interpreted merely as illustrative of the present novel concept and not as a limitation. As such, it is intended that the subject novel concept be construed as including all such modifications and alterations insofar as they come within the scope of the appended claims and any equivalents thereof.

1. An air spring and damper assembly comprising:
a damper including a first damping member and a second damping member displaceably supported on said first damping member, said first damping member including a first wall at least partially defining a damping chamber containing a first quantity of fluid at a nominal pressure of approximately 175 psi or greater;
an air spring including a first end member supported on said first damping member, a second end member spaced from said first end member and supported on said second damping member, and a flexible wall secured between said first and second end members and at least partially defining a spring chamber for containing a second quantity of fluid.

2. An air spring and damper assembly according to claim 1 further comprising a second quantity of fluid at a nominal pressure of approximately 175 psi or greater within said spring chamber.

3. An air spring and damper assembly according to claim 1, wherein said nominal pressure of said first quantity of fluid is approximately 200 psi or greater.

4. An air spring and damper assembly according to claim 3 further comprising a second quantity of fluid at a nominal pressure of approximately 200 psi or greater within said spring chamber.

5. An air spring and damper assembly according to claim 1, wherein said nominal pressure of said first quantity of fluid is approximately 225 psi or greater.

6. An air spring and damper assembly according to claim 5 further comprising a second quantity of fluid at a nominal pressure of approximately 225 psi or greater within said spring chamber.

7. An air spring and damper assembly according to claim 1, wherein said nominal pressure of said first quantity of fluid is approximately 250 psi or greater.

8. An air spring and damper assembly according to claim 7 further comprising a second quantity of fluid at a nominal pressure of approximately 250 psi or greater within said spring chamber.

9. An air spring and damper assembly according to claim 1, wherein said nominal pressure of said first quantity of fluid is approximately 275 psi or greater.

10. An air spring and damper assembly according to claim 9 further comprising a second quantity of fluid at a nominal pressure of approximately 275 psi or greater within said spring chamber.

11. An air spring and damper assembly according to claim 1, wherein said first quantity of fluid includes a liquid.

12. An air spring and damper assembly according to claim 11, wherein said first quantity of fluid includes a gas.

13. An air spring and damper assembly according to claim 12, wherein said gas is one of dispersed in said liquid or substantially separated from said liquid.

14. An air spring and damper assembly according to claim 1 further comprising a second quantity of fluid within said spring chamber, said second quantity of fluid having a nominal pressure not more than approximately 15 percent greater than said nominal pressure of said first quantity of fluid.

15. An air spring and damper assembly according to claim 1 further comprising a restraining device supported on one of said damper or said air spring, said restraining device including a device wall extending along an exterior portion of said flexible wall.

16. An air spring and damper assembly according to claim 15, wherein said device wall of said restraining device is metal.

17. A vehicle suspension system for use on an associated vehicle having an associated sprung mass, an associated unsprung mass, and an associated electrical power source, said vehicle suspension system comprising:
a plurality of suspension members secured between the associated sprung mass and the associated unsprung mass, said suspension members comprising:
a damper including a first damper member and a second damper member displaceably supported on said first damper member, said first damper member including a first wall at least partially defining a damper chamber and a first quantity of fluid disposed within said damper chamber at a nominal pressure of approximately 175 psi or greater;
an air spring supported on said damper, said air spring including a first end member supported on said first damper member, a second end member spaced from said first end member and supported on said second damper member, a flexible wall secured between said first and second end members and at least partially defining a spring chamber therebetween, and a second quantity of fluid disposed within said spring chamber at a nominal pressure of approximately 175 psi or greater; and,
a restraining device supported on one of said damper and said air spring and including a device wall extending along said flexible wall of said air spring;
a pressurized fluid source in fluid communication with said air springs of said plurality of suspension members, said pressurized fluid source selectively communicating said second quantity of fluid to said spring chambers of said air springs; and,
an electronic control unit in communication with the associated electrical power source and said pressurized fluid source, said electronic control unit selectively energizing said pressurized fluid source.

18. A vehicle suspension system according to claim 17 further comprising a control panel in communication with said electronic control unit.

19. A vehicle suspension system kit comprising:
a plurality of dampers, each damper including a first damper portion and a second damper portion displaceable relative to said first damper portion, said first damper portion including a first wall at least partially defining a damper chamber and a first quantity of fluid disposed within said damper chamber at a nominal pressure of approximately 175 psi or greater;
a plurality of air springs with each of said air springs supported on one of said plurality of dampers, said air springs including a first end member supported on said first damper portion, a second end member spaced from said first end member and supported on said second damper portion, and a flexible wall secured between said first and second end members and at least partially defining a spring chamber therebetween; and,
a plurality of restraining devices with each restraining device supported on a corresponding one of said dampers or said air springs, said restraining devices including a device wall extending along said flexible wall of a corresponding one of said air springs;
a pressurized air source adapted to selectively supply pressurized fluid of approximately 175 psi or greater; and,
an electronic control unit operable to selectively energize said pressurized air source.

20. A vehicle suspension system kit according to claim 19 further comprising a control panel adapted for communication with said electronic control unit.
